(19) United States
(12) Patent Application Publication
(10) Pub. No.: US 2011/0063449 A1
(43) Pub. Date: Mar. 17, 2011

(54) SURVEILLANCE CAMERA DEVICE

(76) Inventor: Hyun Gon Lee, Gyeonggi-do (KR)

(21) Appl. No.: 12/990,603

(22) PCT Filed: May 28, 2009
(86) PCT No.: PCT/KR2009/002839

§ 371 Date: Nov. 1, 2010

(30) Foreign Application Priority Data
May 29, 2008 (KR) 10-2008-0020192

(51) Int. Cl. H04N 7/18

(52) U.S. Cl. 348/159; 348/143; 348/E07.085

(57) ABSTRACT

Disclosed is a surveillance camera device for photographing at least one subject located around the camera device. The surveillance camera device includes a rotating module, a rotation driving module, and a camera module. The rotating module is rotatably provided to support the camera module. The driving module rotates the rotating module in parallel to the ground. The camera module is disposed at one side of the rotating module to rotate together with the rotating module in the same direction and continuously photographs the subject by sequentially scanning the subject in a line unit through rotation of the rotating module. The camera module rotates to sequentially scan the subject in a line unit, thereby widening the surveillance range, improving the photographing speed, and obtaining photographing images without distortion.

### TECHNICAL FIELD

The present invention relates to a surveillance camera device. More particularly, the present invention relates to a surveillance camera device capable of photographing subjects around the surveillance camera device by sequentially scanning the surveillance region in a line unit.

### BACKGROUND ART

The security and surveillance system has become more important because the protection and surveillance for the human resources and technical resources are increasingly required as the modern society is rapidly changed. For example, security cameras are installed at the ceiling or walls of banks or public buildings that require the security to photograph and record persons of improper behavior, thereby preventing the accident or the crime in advance. Data recorded in the security cameras are very useful to find the cause of the accident or the crime. Recently, the security cameras have been extensively used at factories and parks for the purpose of crime prevention and fire protection.

When the security camera is used in the building, the security camera is installed at the ceiling or the upper portion of the inner wall of the building. In addition, when the security camera is used in the outdoors, the security camera is installed to the outer wall of the building at a proper height by using a support to surveil the predetermined region. In particular, a panorama surveillance camera having the omni-directional surveillance function is installed in a display of a base station, which monitors the surveillance region, to photograph the wide surveillance region and to monitor the surveillance region at a time.

The panorama surveillance camera includes a photographing part, which is rotatably installed to photograph subjects existing in the surveillance region. For instance, the photographing part is attached to a rotating plate that rotates without moving, so that the photographing part may rotate together with the rotating plate while photographing the subjects existing in the surveillance region.

The panorama surveillance camera includes a lens to focus the subjects existing in the surveillance region, and an image sensor for sensing images of the subjects focused by the lens. An area image sensor having a plurality of pixels arranged in a rectangular configuration is mainly used as the image sensor.

Meanwhile, the panorama surveillance camera employing the area image sensor photographs the first region corresponding to the area where the pixels are arranged, and then rotates by a predetermined angle to photograph the second region adjacent to the first region. In addition, the panorama surveillance camera combines the image of the first region with the image of the second region for the purpose of the omni-directional surveillance. At this time, distortion may occur between the images of the first and second regions obtained by the panorama surveillance camera. In addition, the image processing work must be additionally performed to combine the images of the first and second regions with each other, so that the photographing speed is remarkably delayed and the photographing cost is increased.

### DISCLOSURE

### Technical Problem

The present invention has been made to solve the problems occurring in the related art, and an object of the present invention is to provide a surveillance camera device capable of providing photographing images having no distortion while reducing the photographing time and photographing cost by sequentially scanning subjects existing in the surveillance region in a line unit.

### Technical Solution

In order to accomplish the above object, according to one embodiment of the present invention, there is provided a surveillance camera device to surveil the surveillance region by photographing at least one subject located around the surveillance camera device. The surveillance camera device includes a rotating module, a rotation driving module and a camera module. The rotating module is rotatably provided to support the camera module. The rotation driving module rotates the rotating module in parallel to the ground. The camera module is disposed on one side of the rotating module to rotate together with the rotating module in the same direction and continuously photographs the subject by sequentially scanning the subject in a line unit through rotation of the rotating module.

According to the embodiment of the present invention, the rotating module rotates without moving and includes a rotating plate connected to the rotation driving module to rotate in one direction or bi-direction. The camera module is disposed at one side of a top surface or a bottom surface of the rotating plate to sequentially scan the subject in a line unit through the rotation of the rotating plate.

According to the embodiment of the present invention, the rotation driving module includes a driving motor for generating rotational force to rotate the rotating module and a rotating gear for transferring the rotational force of the driving motor to the rotating module.

According to the embodiment of the present invention, the camera module includes a lens part and a sensor part. The lens part focuses an image of the subject and the sensor part senses the image of the subject focused by the lens part in a line unit. For instance, the sensor part includes a linear image sensor having a plurality of pixels arranged in at least one line to sense the image of the subject in a line unit. The linear image sensor may include a CCD (charged coupled device) image sensor. In addition, the sensor part includes an area image sensor having a plurality of pixels arranged in a rectangular configuration. The area image sensor senses the image of the subject in a line unit by using several pixels arranged in a line unit.

According to the embodiment of the present invention, the surveillance camera device further includes a tilt driving unit. The tilt driving unit tilts the camera module up and down toward the subject in such a manner that the camera module is able to photograph the subject located below the camera module.

According to the embodiment of the present invention, the surveillance camera device further includes a logic part. The logic part processes the image of the subject sensed by the camera module. The logic part is disposed at one side of the rotating module in opposition to the camera module about a rotating shaft of the rotating module to keep a weight balance with the camera module. In addition, the surveillance camera device may further include a power supply part, a controller, and a data transmission part. The power supply part supplies power to the camera module and the logic part. The controller digitally controls the logic part and controls the rotation driving module and the tilt driving unit to adjust rotation and tilting of the camera module. The data transmission part transmits image data processed by the logic part to the controller.

In order to accomplish the above object, according to another embodiment of the present invention, there is provided a surveillance camera device to surveil the surveillance region by photographing at least one subject located around the surveillance camera device. The surveillance camera device may include a support, a rotating plate, a rotation driving module, and a plurality of camera modules. The rotating plate is rotatably installed on the support. The rotation driving module is connected to the rotating plate to rotate the rotating plate in parallel to the ground. The camera modules are disposed on a top surface or a bottom surface of the rotating plate while being spaced apart from each other to rotate together with the rotating plate in the same direction and continuously photograph the subject by sequentially scanning the subject in a line unit through rotation of the rotating plate.

According to the embodiment of the present invention, each camera module includes a leans part and a sensor part. The lens part focuses an image of the subject and the sensor part senses the image of the subject focused by the lens part in a line unit. For instance, the sensor part includes a linear image sensor having a plurality of pixels arranged in at least one line to sense the image of the subject in a line unit. In addition, the sensor part may include an area image sensor having a plurality of pixels arranged in a rectangular configuration. The area image sensor senses the image of the subject in a line unit by using several pixels arranged in a line unit.

According to the embodiment of the present invention, the surveillance camera device may further include a tilt driving unit. The tilt driving unit tilts the camera module up and down toward the subject in such a manner that the camera module is able to photograph the subject located below the camera module.

### ADVANTAGEOUS EFFECTS

As described above, according to the surveillance camera device of the present invention, the camera module photographs the surveillance region while rotating, so that the surveillance camera device can omni-directionally surveil the surveillance region.

In addition, the surveillance camera device can continuously photograph the subjects by sequentially scanning the subjects existing in the surveillance region in a line unit, so that the dynamic images and still pictures can be continuously and rapidly obtained without distortion.

Further, since the camera module can be tilted up and down, the photographing angle of the camera module with respect to the ground can be variously adjusted, so that the wide photographing range can be ensured. In particular, the camera module is installed at the lower portion of the surveillance camera device so that the camera module can effectively photograph the subjects even if the subjects are located out of the photographing region, thereby minimizing the photographing dead zone and widening the surveillance region.

### DESCRIPTION OF DRAWINGS

FIG. 1 is a schematic view showing the structure of a surveillance camera device according to one embodiment of the present invention;

FIGS. 2 and 3 are views showing examples of a sensor part shown in FIG. 1;

FIG. 4 is a view showing an operational state of a surveillance camera device shown in FIG. 1;

FIG. 5 is a schematic view showing the structure of a surveillance camera device according to another embodiment of the present invention; and

FIG. 6 is a schematic view showing the structure of a surveillance camera device according to still another embodiment of the present invention.

### BEST MODE

### Mode for Invention

Hereinafter, a surveillance camera device according to the exemplary embodiments of the present invention will be described in detail with reference to accompanying drawings. Those skilled in the art will appreciate that various modifications, additions and substitutions are possible, without departing from the scope and spirit of the invention as disclosed in the accompanying claims and their equivalents. The same reference numerals will be used to refer to the same elements through the drawings. In addition, the thickness and size of some components shown in the drawings can be magnified, reduced or schematically drawn to clarify or comprehend the present invention.

The terms “first” and “second” can be used to explain various elements but the elements are not limited to such terms. The terms are used to distinguish one element from the other element. Thus, an element referred to as a first element in one embodiment can be referred to as a second element in another embodiment.

Unless defined otherwise, the terms including technical terms or scientific terms used herein may have the meanings normally understandable by the person having the ordinary skill in the art. The terms defined in the dictionary may be interpreted based on the context thereof available in the related technology and they must not be ideally or excessively interpreted unless the context otherwise requires.

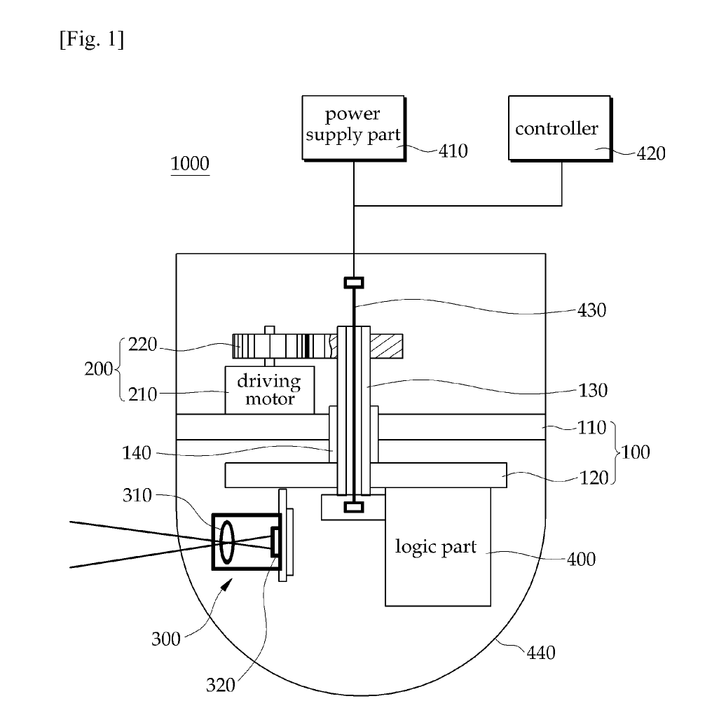

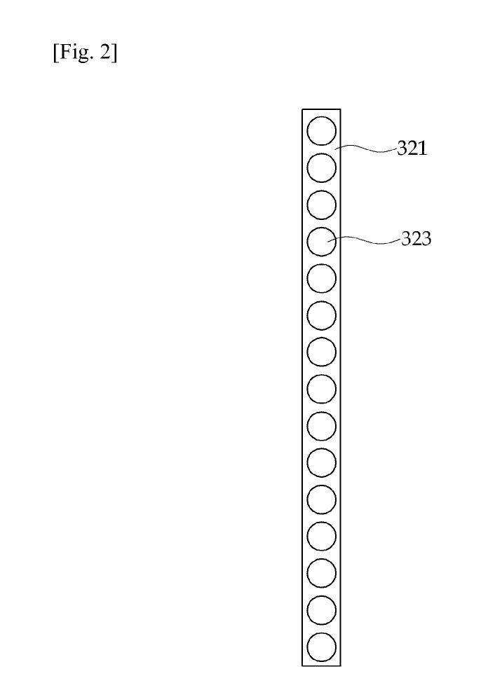

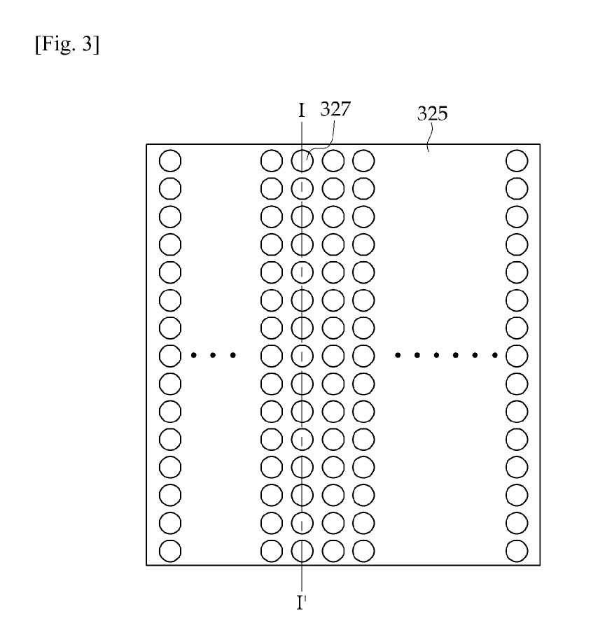

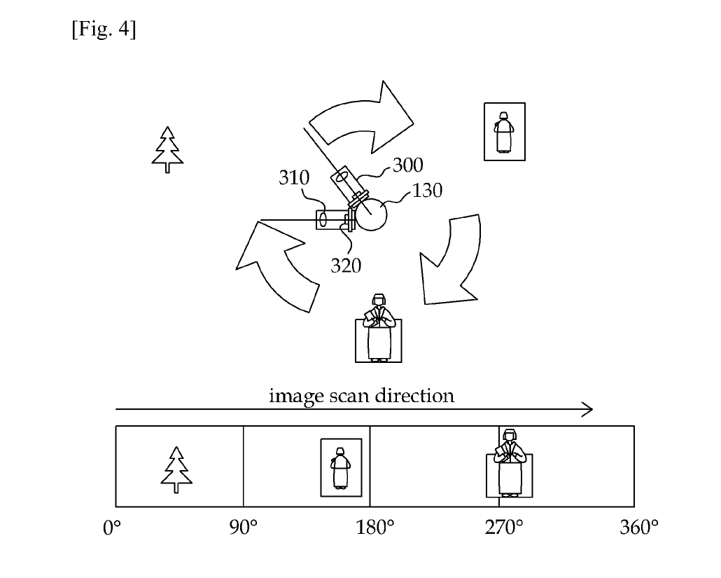

FIG. 1 is a schematic view showing the structure of a surveillance camera device according to one embodiment of the present invention, FIGS. 2 and 3 are views showing examples of a sensor part shown in FIG. 1, and FIG. 4 is a view showing the operational state of the surveillance camera device shown in FIG. 1.

Referring to FIG. 1, the surveillance camera device 1000 according to one embodiment of the present invention photographs at least one subject located around the surveillance camera device 1000. For instance, the surveillance camera device 1000 continuously and omni-directionally photographs the subjects existing in the surveillance region. To this end, the surveillance camera device 1000 includes a rotating module 100, a rotation driving module 200 and a camera module 300.

The rotating module 100 supports the camera module 300 and rotates in one direction or bi-direction. The rotating module 100 includes a support 110, a rotating plate 120 and a rotating shaft 130.

The support 110 is installed in the surveillance camera device 1000. For instance, the support 110 is installed in a middle part in the internal cavity of the surveillance camera device 1000 and fixed to an inner wall of the surveillance camera device 1000. In addition, the support 110 may have a hollow structure such that the rotating shaft 130 can extend through the support 110. Since a bearing 140 is disposed between the support 110 and the rotating shaft 130, the rotating shaft 130 can be stably inserted into the support 110 and rotated therein.

In addition, the support 110 divides the internal cavity of the surveillance camera device 1000 into an operation region where the camera module 300 is operated and an installation region where the rotation driving module 200 is installed.

The rotating plate 120 is rotatably coupled with the support 110. For instance, the rotating plate 120 is connected to a lower end of the rotating shaft 130 extending through the support 110. That is, the rotating plate 120 is connected to the support 110 by the rotating shaft 130. Meanwhile, the rotating plate 120 is rotated without moving or the rotating plate 120 moves around the rotating shaft 130 in a predetermined orbit. Since the main function of the rotating plate 120 is the rotation, the rotating plate 120 moving along the predetermined orbit is also within the scope of the present invention.

The rotation driving module 200 rotates the rotating module 100. According to the embodiment of the present invention, the rotation driving module 200 may rotate the rotating module 100 in parallel to the ground. To this end, the rotation driving module 200 includes a driving motor 210 for generating rotational force to rotate the rotating module 100 and a rotating gear 220 for transferring the rotational force of the driving motor 210 to the rotating module 100.

The rotation driving module 200 is fixedly installed on the support 110 of the rotating module 100. In addition, the rotation driving module 200 can be fixed to the inner wall of the surveillance camera device 1000.

The camera module 300 is installed at one side of the rotating module 100. According to the embodiment of the present invention, the camera module 300 is installed at one side of the top surface or the bottom surface of the rotating plate 120 of the rotating module 100. For example, the camera module 300 is fixedly installed at an edge of the bottom surface of the rotating plate 120. Therefore, as the rotating module 100 rotates, the camera module 300 is rotated together with the rotating module 100 in the same direction. Thus, the camera module 300 can omni-directionally photograph the surveillance region.

The camera module 300 for photographing the subjects located around the camera module 300 includes a lens part for focusing the image of the subject and a sensor part 320 for sensing the image of the subject.

The lens part 310 is provided at a front end of the camera module 300 on the basis of the subject to focus the image signal of the subject to the sensor part 320. The lens part 310 obtains the image signal for the subject according to the predetermined control signal. The lens part 310 may include a convex lens.

The sensor part 320 is provided at a rear end of the camera module 300 on the basis of the subject. For instance, the sensor part 320 can be located at a position where the image of the subject is focused by the lens part 310.

The sensor part 320 converts the optical signal, which is the image signal of the subject obtained by the lens part 310, into the electric signal. For instance, the lens part 320 may include a CCD (charge coupled device) image sensor, or a CMOS (complementary metal oxide semiconductor) image sensor. If the sensor part 320 includes the CCD image sensor, the sensor part 320 outputs current in response to light to sense the image of the subject.

According to the exemplary embodiments of the present invention, the sensor part 320 scans the subject in a line unit. That is, the sensor part 320 including a plurality of pixels senses the optical signal of the lens part 310 by using pixels arranged in a line unit.

Referring to FIG. 2, the sensor part 320 includes a linear image sensor 321 having a plurality of pixels 323 arranged in a line unit. That is, since the linear image sensor 321 includes pixels 323 arranged in a line unit, the linear image sensor 321 senses the optical signal for the image of the subject, which is obtained by the lens part 310, in a line unit.

Although not shown in the drawings, three lines are prepared as a set in the linear image sensor 321, in which each line includes a plurality of pixels 323. The three lines may correspond to red R, green G and blue B, respectively. That is, the linear image sensor 321 may include a color image sensor as well as a monochromatic image sensor.

Referring to FIG. 3, the sensor part 320 may include an area image sensor 325 including a plurality of pixels 327 arranged in a rectangular configuration. The area image sensor 325 can sense the optical signal for the image of the subject in a line unit by using several pixels arranged in a line unit. For instance, the area image sensor 325 can sense the optical signal of the lens part 310 using some pixels 327 arranged in a line unit I-I′ without using all pixels 327.

Referring to FIG. 4, the second part 320 of the rotatable camera module 300 can continuously photograph the subject by sequentially scanning the subjects in a line unit. For instance, the camera module 300 is rotatable at an angle of 360° about the rotating shaft 130 to scan and photograph the subjects existing in the surveillance region. That is, as shown in FIG. 4, the camera module 300 scans the subjects, such as wood, a woman with one-piece dress and a person with patient cloth, in a line unit to continuously photograph the subjects. That is, the camera module 300 can repeatedly and continuously photograph the subjects in a line unit.

Referring again to FIG. 1, the surveillance camera device 1000 may further include a logic part 400, a power supply part 410, a controller 420, a data transmission part 430 and a transparent window 440.

The logic part 400 processes the image of the subject sensed by the camera module 300 into the digital signal. In detail, the logic part 400 converts the image signal of the subject, which is converted into the electric signal through the sensor part 320, into the digital image signal. The logic part 400 may include a typical digital logic unit capable of converting the electric signal into the digital signal.

In addition, the logic part 400 may balance the weight with the camera module 300 about the rotating shaft of the rotating module 100. If the center of gravity of the rotating module 100 is biased due to the camera module 300 installed at one side of the rotating module 100, the rotating module 100 may not normally rotate. Thus, the logic part 400 is located in opposition to the camera module 300 about the rotating shaft 130 to balance the center of gravity.

The power supply part 410 supplies power to the camera module 300 and the logic part 400. The power supply part 410 can be installed inside or outside the surveillance camera device 1000. The power supply part 410 supplies power to the camera module 300 and the logic part 400 through a power supply line (not shown). The power supply line can be formed by passing through the inside of the rotating shaft 130. The power supply part 410 may include a portable power supply device employing a rechargeable battery.

The controller 420 controls the operation, the function and the signal processing of the surveillance camera device 1000. The controller digitally controls the logic part 400. That is, the controller 420 controls the signal processing operation of the logic part 400 and transmits the digital signal from the logic part 400 to the external display device. At this time, the controller 420 may amplify or convent the digital signal transmitted to the external display device.

In addition, the controller 420 controls the rotation driving module 200 to control the rotation of the rotating plate 120 of the rotating module 100. As a result, the controller 420 controls the rotation of the camera module 300 suitably for the surveillance region and surveillance targets, so that the surveillance capability can be improved.

The data transmission part 430 transmits the digital signal processed by the logic part 400 to the controller 420. That is, the data transmission part 430 is a signal transmission part for transmitting the digital image signal processed by the logic part 400 to the controller 420. Meanwhile, the data transmission part 430 can be formed by utilizing the internal cavity of the rotating shaft 130 having the hollow structure.

The transparent window 440 surrounds the camera module 300. The transparent window 440 includes a transparent material which does not interfere with the photographing operation of the camera module 300. In addition, the transparent window 440 protects the camera module 300 from external impact. Thus, the transparent window 440 may have predetermined strength.

As described above, the surveillance camera device 1000 scans the subjects existing in the surveillance region in a line unit while rotating, so that the surveillance camera device 1000 can continuously photographs the subjects without distortion. Thus, the surveillance camera device 1000 can omni-directionally surveil the surveillance region and can continuously provide the still pictures and dynamic images without distortion.

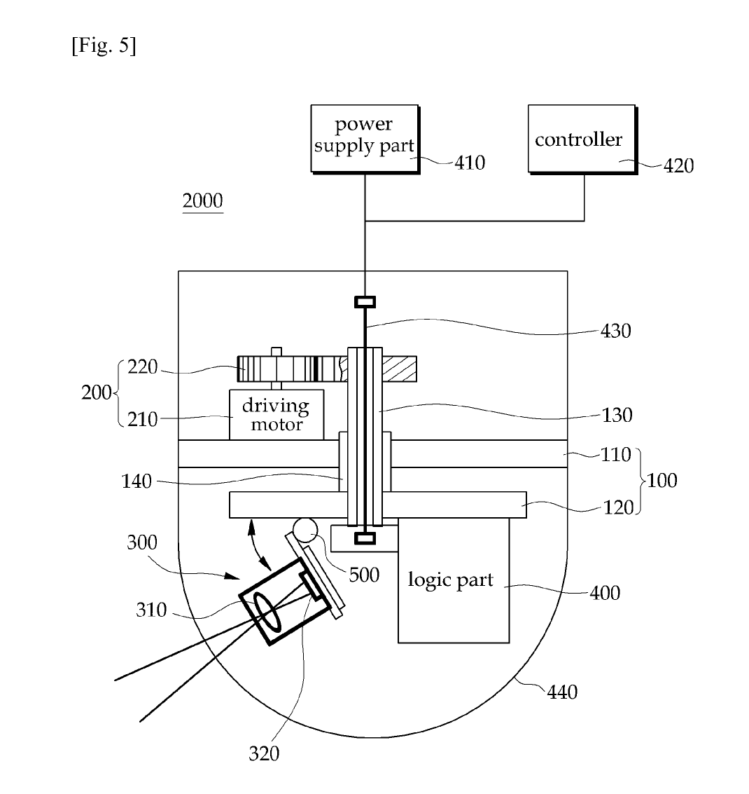

FIG. 5 is a schematic view showing the structure of a surveillance camera device according to another embodiment of the present invention. The surveillance camera device according to another embodiment of the present invention is identical to the surveillance camera device 1000 shown in FIG. 1, except for a tilt driving unit. Thus, details of the elements and structures that have been described with reference to FIG. 1 will be omitted in order to avoid redundancy and the same reference numerals will be used to refer to the same elements.

Referring to FIG. 5, the surveillance camera device 2000 according to another embodiment of the present invention includes the tilt driving unit 500 for tilting the camera module 300 up and down.

The tilt driving unit 500 tilts the camera module 300 toward the subject to photograph the subject located below the surveillance camera device 2000. That is, the tilt driving unit 500 adjusts the photographing angle of the camera module 300 up and down to photograph the subject located in the dead zone of the surveillance camera device 2000. The term. “photographing angle” refers to the photographing range of the camera module 300. The photographing angle includes the vertical photographing angle as well as the horizontal photographing angle. The tilt driving unit 500 tilts the camera module 300 in the longitudinal direction.

Meanwhile, the tilt driving unit 500 includes a stepping motor to allow the camera module 300 to be tilted up and down step by step. In addition, the tilt driving unit 500 may include a tilt motor or a driving motor to continuously operate the camera module 300 up and down.

The controller 420 controls the tilt driving unit 500 to adjust the up-down movement of the camera module 300. The controller 420 can periodically controls the up-down movement of the camera module 300. In addition, if the subject located in the dead zone is detected by an additional sensor, the controller 420 controls the up-down movement of the camera module 300. Further, the controller 420 can control the tilt driving unit in various manners depending on the parameters, such as the tilt angle and the photographing angle of the camera module 300.

Since the tilt driving unit 500 tilts the camera module 300 up and down, the photographing angle can be widened, so that the dead zone of the surveillance region can be minimized and the surveillance region can be expanded.

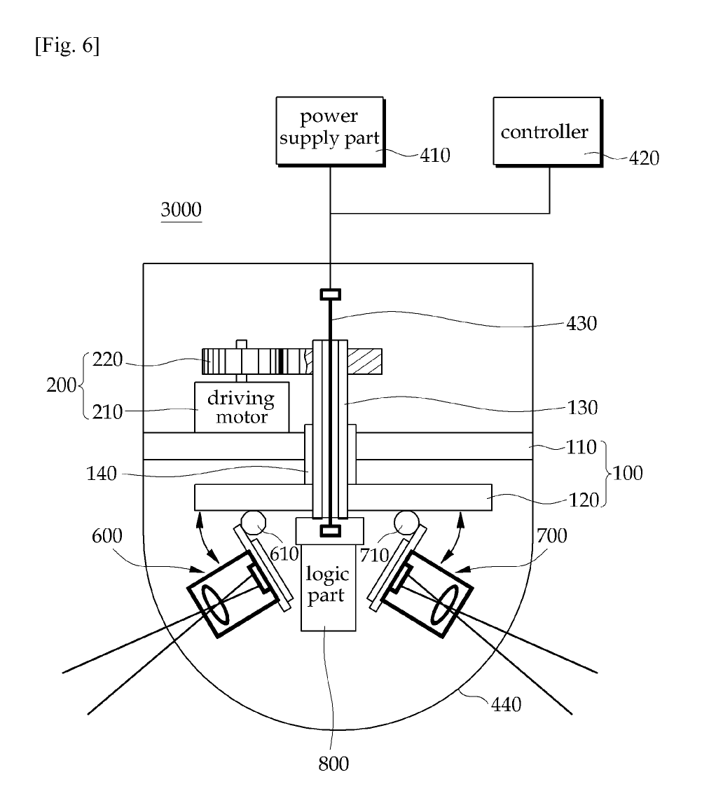

FIG. 6 is a schematic view showing the structure of a surveillance camera device according to still another embodiment of the present invention.

The surveillance camera device according to still another embodiment of the present invention is identical to the surveillance camera device 1000 shown in FIG. 1, except for the camera module. Thus, details of the elements and structures that have been described with reference to FIG. 1 will be omitted in order to avoid redundancy and the same reference numerals will be used to refer to the same elements.

Referring to FIG. 6, the surveillance camera device 3000 according to still another embodiment of the present invention includes first and second camera modules 600 and 700 installed at both sides of the rotating module 100.

The first camera module 600 is installed at one side of the rotating plate 120 of the rotating module 100 and the second camera module 700 is installed at the other side of the rotating plate 120 of the rotating module 100 in opposition to the first camera module 600. The first and second camera modules 600 and 700 are identical to the camera module 300 described with reference to FIG. 1, details thereof will be omitted in order to avoid redundancy.

Meanwhile, the surveillance camera device 3000 may include at least three camera modules which are regularly spaced apart from each other on the top surface or the bottom surface of the rotating plate 120.

In detail, the surveillance camera device 3000 includes first and second tilt driving units 610 and 710 for driving the first and second camera modules 600 and 700 up and down. The first and second tilt driving units 610 and 710 adjust the photographing angle of the first and second camera modules 600 and 700 up and down to photograph the subjects located below the surveillance camera device 3000. The first and second tilt driving units 610 and 710 are identical to the tilt driving unit 500 described with reference to FIG. 4, so details thereof will be omitted in order to avoid redundancy.

According to the exemplary embodiment of the present invention, the controller 420 controls the rotational speed and the number of rotations of the first and second camera modules 600 and 700 rotatably attached to the rotating plate 120. In addition, the controller 420 controls the first and second tilt driving units 610 and 710 to adjust the vertical photographing angles of the first and second camera modules 600 and 700. The controller 420 can synchronously or differentially control the first and second tilt driving units 610 and 710. That is, the controller 420 can simultaneously control the up-down movement of the first and second camera modules 600 and 700, or selectively or sequentially control up-down movement of the first and second camera modules 600 and 700 depending on situations.

The logic part 800 converts the image signal transmitted from the first and second camera modules 600 and 700 into the digital signal. The logic part 800 and/or the controller 420 can perform the image processing work to combine the image signals, which are transmitted from various camera modules, with each other.

Meanwhile, the logic part 800, which converts the image signal of the first and second camera modules 600 and 700 into the digital signal, is disposed adjacent to the center of the rotating plate 120 in order to prevent the rotational center of the rotating plate 120 from being biased or shifted caused by the logic part 800. According to the embodiment of the present invention, the logic part 800 is disposed in line with the rotating shaft 130.

As described above, the surveillance camera device 3000 includes a plurality of camera modules such that the photographing range of each camera module can be minimized, thereby improving the photographing speed. In addition, the surveillance camera device 3000 can individually control the vertical photographing angle of the camera modules, so that the photographing range can be maximized.

Although the exemplary embodiments of the present invention have been described for illustrative purposes, those skilled in the art will appreciate that various modifications, additions and substitutions are possible, without departing from the scope and spirit of the invention as disclosed in the accompanying claims.

### INDUSTRIAL APPLICABILITY

According to the surveillance camera device of the present invention, the camera module photographs the surveillance region while rotating, so the camera module can omni-directionally photograph the surveillance region. In addition, since the camera module can continuously photograph the subjects by scanning the subjects existing in the surveillance region in a line unit, the image can be obtained without distortion, the photographing speed can be improved and the photographing cost can be reduced. In addition, since the photographing angle of the camera module can be adjusted in the longitudinal direction by tilting the camera module up and down, the dead zone of the surveillance camera device may be minimized and the wide surveillance region can be ensured. Further, the surveillance region can be divisionally photographed by a plurality of camera modules, so that the photographing speed can be improved.

1. A surveillance camera device including a camera module to photograph at least one subject located around the surveillance camera device, the surveillance camera device comprising:
a rotating module rotatably provided to support the camera module;
a rotation driving module for rotating the rotating module in parallel to a ground; and
the camera module, which is disposed on one side of the rotating module to rotate together with the rotating module in a same direction and continuously photographs the subject by sequentially scanning the subject in a line unit through rotation of the rotating module.

2. The surveillance camera device of claim 1, wherein the rotating module rotates without moving and includes a rotating plate connected to the rotation driving module to rotate in one direction or bi-direction, and the camera module is disposed at one side of a top surface or a bottom surface of the rotating plate to sequentially scan the subject in a line unit through the rotation of the rotating plate.

3. The surveillance camera device of claim 1, wherein the rotation driving module includes a driving motor for generating rotational force to rotate the rotating module and a rotating gear for transferring the rotational force of the driving motor to the rotating module.

4. The surveillance camera device of claim 1, wherein the camera module includes a lens part to focus an image of the subject and a sensor part to sense the image of the subject focused by the lens part in a line unit.

5. The surveillance camera device of claim 4, wherein the sensor part includes a linear image sensor having a plurality of pixels arranged in at least one line to sense the image of the subject in a line unit.

6. The surveillance camera device of claim 5, wherein the linear image sensor includes a CCD (charged coupled device) image sensor.

7. The surveillance camera device of claim 4, wherein the sensor part includes an area image sensor having a plurality of pixels arranged in a rectangular configuration, and the area image sensor senses the image of the subject in a line unit by using several pixels arranged in a line unit.

8. The surveillance camera device of claim 1, further comprising a tilt driving unit, wherein the tilt driving unit tilts the camera module up and down toward the subject in such a manner that the camera module is able to photograph the subject located below the camera module.

9. The surveillance camera device of claim 1, further comprising a logic part for processing an image of the subject sensed by the camera module, wherein the logic part is disposed at one side of the rotating module in opposition to the camera module about a rotating shaft of the rotating module to keep a weight balance with the camera module.

10. The surveillance camera device of claim 9, further comprising:
a power supply part for supplying power to the camera module and the logic part;
a controller that digitally controls the logic part and controls the rotation driving module and the tilt driving unit to adjust rotation and tilting of the camera module; and
a data transmission part for transmitting image data processed by the logic part to the controller.

11. A surveillance camera device for photographing at least one subject located around the surveillance camera device, the surveillance camera device comprising:
a support;
a rotating plate rotatably installed on the support;
a rotation driving module connected to the rotating plate to rotate the rotating plate in parallel to a ground; and
a plurality of camera modules, which are disposed on a top surface or a bottom surface of the rotating plate while being spaced apart from each other to rotate together with the rotating plate in a same direction and continuously photograph the subject by sequentially scanning the subject in a line unit through rotation of the rotating plate.

12. The surveillance camera device of claim 11, wherein each camera module includes a lens part to focus an image of the subject and a sensor part to sense the image of the subject focused by the lens part in a line unit.

13. The surveillance camera device of claim 12, wherein the sensor part includes a linear image sensor having a plurality of pixels arranged in at least one line to sense the image of the subject in a line unit.

14. The surveillance camera device of claim 12, wherein the sensor part includes an area image sensor having a plurality of pixels arranged in a rectangular configuration, and the area image sensor senses the image of the subject in a line unit by using several pixels arranged in a line unit.

15. The surveillance camera device of claim 11, further comprising a tilt driving unit, wherein the tilt driving unit tilts the camera module up and down toward the subject in such a manner that the camera module is able to photograph the subject located below the camera module.
